(19) United States
(12) Patent Application Publication
(10) Pub. No.: US 2014/0245287 A1
(43) Pub. Date: Aug. 28, 2014

(54) EFFECTIVE INSTALLATION OF APPLICATION SOFTWARE PRODUCT

(71) Applicant: KYOCERA DOCUMENT SOLUTIONS INC., Osaka (JP)

(72) Inventor: Yuki ENOKIZONO, Osaka (JP)

(73) Assignee: KYOCERA DOCUMENT SOLUTIONS INC., Osaka (JP)

(21) Appl. No.: 14/189,868

(22) Filed: Feb. 25, 2014

(30) Foreign Application Priority Data
Feb. 28, 2013 (JP) 2013-0040162

(51) Int. Cl. G06F 9/445

(52) U.S. Cl. CPC G06F 8/61
USPC 717/175

(57) ABSTRACT

An electronic device includes a storage unit, a storage control unit, and a link unit. The storage unit is configured to store an application software product. The storage control unit is configured to: compare functions of an existing application software product already stored in the storage unit with functions of a new application software product to be installed; control the storage unit to store a file for a function not duplicative with the existing application software product; and control the storage unit not to store a file for a duplicative function, for the new application software product. The link unit is configured to link location information of the file for the duplicative function of the existing application software product to a position where the file for the function not stored due to the duplication is to be written in the new application software product stored in the storage unit.

### CROSS-REFERENCE TO RELATED APPLICATION

This application is based upon, and claims the benefit of priority from, corresponding Japanese Patent Application No. 2013-0040162, filed in the Japan Patent Office on Feb. 28, 2013, the entire contents of which are incorporated herein by reference.

### BACKGROUND OF THE INVENTION

Unless otherwise indicated herein, the description in this section is not prior art to the claims in this application and is not admitted to be prior art by inclusion in this section.

Recently, an image forming apparatus that can cause addition and complement of a function desired by a user by installing application software has been developed often. However, there may be a case where installation of a plurality of application software may duplicate a function of the already-installed application software. The duplicative function wastes a memory resource.

Therefore, a technique that reduces a waste of memory using an application software product installed in another device, which is connected via network, has been proposed. Meanwhile, in the case where both executable application software products before and after version upgrade are held, the same files may be redundantly installed and waste a memory resource. Thus, for a case where a file constituting application software product after a version upgrade is the same as the file before the version upgrade, a technique that links the file of the application software product before the version upgrade to use as the file of the application software product after the version upgrade has been proposed. This does not install the same file redundantly, thus saving a memory resource.

### SUMMARY OF THE INVENTION

An electronic device according to an exemplary embodiment of the disclosure a storage unit, a storage control unit, and a link unit. The storage unit is configured to store an application software product. The storage control unit is configured to: compare functions of an existing application software product already stored in the storage unit with functions of a new application software product to be installed; control the storage unit to store a file for a function not duplicative with the existing application software product; and control the storage unit not to store a file for a duplicative function, for the new application software product. The link unit is configured to link location information of the file for the duplicative function of the existing application software product to a position where the file for the function not stored due to the duplication is to be written in the new application software product stored in the storage unit.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an electrical configuration of an image forming apparatus;

FIG. 2 is a flowchart describing a flow of an installation process;

FIG. 3 illustrates a functional configuration of an application software product;

FIG. 4 illustrates a functional configuration of an application software product;

FIG. 5 is a conceptual diagram illustrating an application software product that has been installed;

FIG. 6 illustrates conceptual diagrams of already installed application software product and application software product newly installed, and illustrates functions of each of the application software product; and

FIG. 7 illustrates conceptual diagrams of already installed application software product and application software product newly installed, and illustrates functions of each of the application software product.

### DETAILED DESCRIPTION OF THE EMBODIMENTS

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an electronic device and an application software storing program according to one embodiment of the disclosure using an exemplary image forming apparatus. In this embodiment, the electronic device of the disclosure will be described using the exemplary image forming apparatus. However, the electronic device may be an electronic device that achieves function enhancement by installing an application software product, such as a personal computer and a mobile phone.

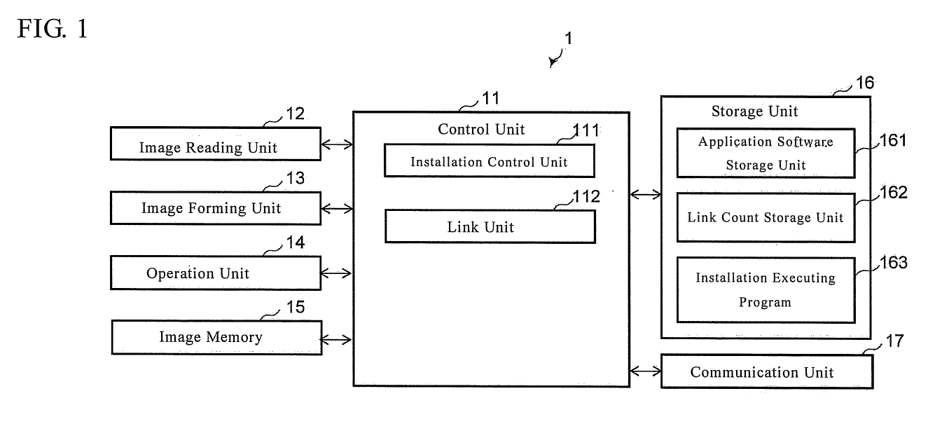

FIG. 1 is a block diagram illustrating an electrical configuration of an image forming apparatus 1 of the embodiment. The image forming apparatus 1 includes a control unit 11, an image reading unit 12, an image forming unit 13, an operation unit 14, an image memory 15, a storage unit 16, and a communication unit 17.

The image reading unit 12 obtains image data by reading an image of a document. The image forming unit 13 forms an image based on the image data on a paper sheet as a recording medium. The operation unit 14 includes an operation key and a display panel with a touchscreen function, such as a Liquid Crystal Display (an LCD). The operation key receives an instruction regarding various operations and processes executable by the image forming apparatus 1 from an operator. The image memory 15 temporarily stores image data obtained by the image reading unit 12.

The storage unit 16 is configured with a rewritable memory or similar storage. The storage unit 16 includes an application software storage unit 161 and a link count storage unit 162 and stores an installation executing program 163. The application software storage unit 161 stores an application software product obtained by the communication unit 17. The installation executing program 163 executes an installation by being read and executed by an installation control unit 111, which will be described later.

The link count storage unit 162 stores a link count of functions of the application software product stored by the application software storage unit 161. The installation executing program 163 is executed by being read by the installation control unit 111 in installation of a new application software product to the image forming apparatus 1.

The communication unit 17 is an interface circuit that communicates with each electronic device via a Local Area Network (LAN) and a Wide Area Network (WAN) to which the image forming apparatus 1 is connected. The communication unit 17 obtains (installs) an application software product from an external server or a similar device.

The control unit 11 is constituted of a Central Processing Unit (a CPU) or a similar unit. The control unit 11 reads various programs stored in the storage unit 16, executes a process, outputs an instruction signal to each functional unit, transfers data, and similar operation to integrally control the image forming apparatus 1. The control unit 11 includes the installation control unit 111 (the storage control unit) and a link unit 112.

The installation control unit 111 reads and runs the installation executing program 163 stored in the storage unit 16 to perform a control for installing an application software product from an external server or similar device. For example, the installation control unit 111 compares functions of the existing application software product, which is already stored in the application software storage unit 161, with functions of the new application software product, which is a target for installation. The installation control unit 111 controls the application software storage unit 161: so as to store files of the new application software product that are not duplicative with the functions of the existing application software product; and so as not to store files for the duplicative functions.

In the case where a file of a new application software product to be installed is the same as a file of the existing application software product already stored in the application software storage unit 161, the link unit 112 links location information of the file of the existing application software product to a position of the file that is not stored due to the duplication for the new application software product.

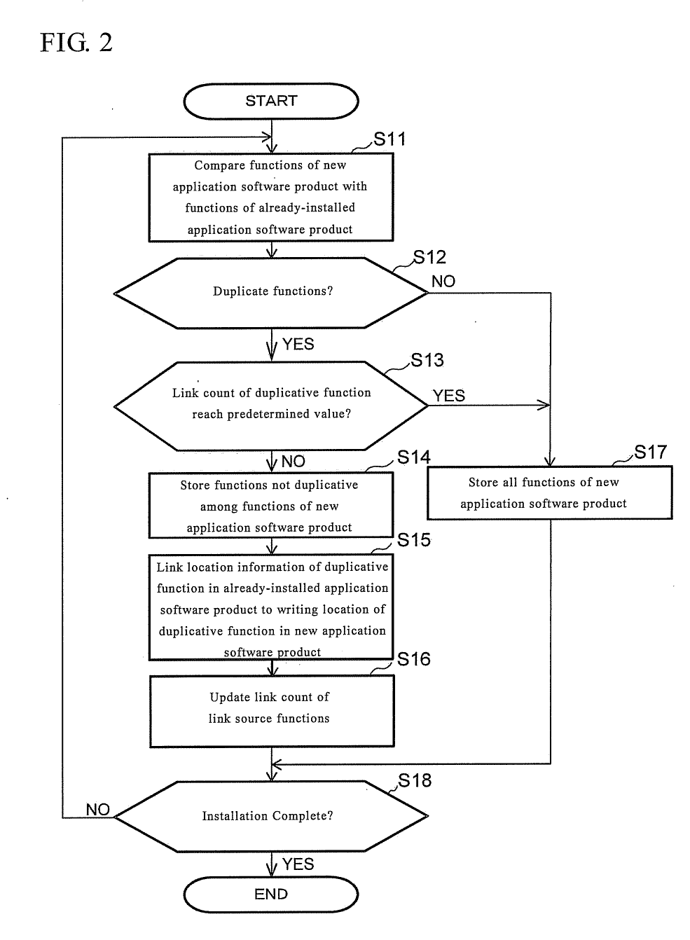

FIG. 2 is a flowchart describing a flow of the installation process in this embodiment. When the control unit 11 accepts an installation instruction of the application software product based on an operation by an operator (a user or a maintenance worker) with the operation unit 14 or a similar operation, the installation control unit 111 starts an installation process by reading and running the installation executing program 163 from the storage unit 16. First, the installation control unit 111 (1) obtains a new application software product (hereinafter simply referred to as “new application software product”) to be installed by downloading from a server connected over network via the communication unit 17 or similar method and temporarily stores the new application software product in a predetermined area in the storage unit 16. Alternatively, the installation control unit 111 (2) accesses the server or a similar device via the communication unit 17, and checks contents of each function of the new application software product.

Subsequently, the installation control unit 111 compares the functions of the new application software product with the functions of the existing application software product already stored in the application software storage unit 161 (hereinafter simply referred to as “already-installed application software product”) (S11). The installation control unit 111 (a) may determine that the functions match or not by verifying programs constituting respective functions or (b) may determine that the functions match or not by verifying identification numbers assigned to respective functions of the application software product. In the case of (b), each application software product to be installed holds a different identification number for each function of the application software product. Thus, determination of match/mismatch of the functions using the identification numbers smoothly performs the comparison process, thus shortening time taken for installation.

In the case where the installation control unit 111 determines that the function of the new application software product matches the function of the already-installed application software product, that is, determines that the functions are duplicative (S12: YES), the installation control unit 111 reads the number of links (described later) of the functions duplicative with other application software products stored in the application software storage unit 161 in the already-installed application software product (hereinafter referred to as a link count) from the link count storage unit 162, and determines whether the link count reaches a predetermined value or not (S13). This preliminary determined value will be described later.

If the installation control unit 111 determines that the link count does not reach the predetermined value (NO: S13), the installation control unit 111 does not store a file for a function duplicative with the function of the already-installed application software product into the application software storage unit 161 and stores a file for a function that is not duplicative into the application software storage unit 161, among functions of the new application software product (S14). That is, the installation control unit 111 installs the new application software product with the duplicative function removed on the application software storage unit 161.

Then, the link unit 112 writes location information, which indicates a position where the file for the duplicative function is written in the already-installed application software product in the application software storage unit 161, to the position where the file for the duplicative function is to be written in the new application software product. Accordingly, the file for the duplicative function of the already-installed application software product is linked to the new application software product (S15).

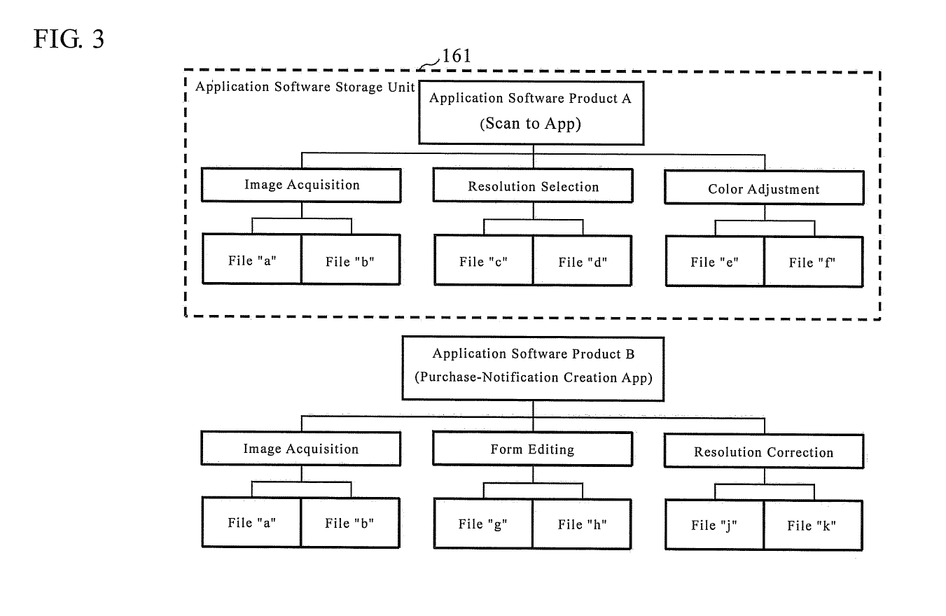

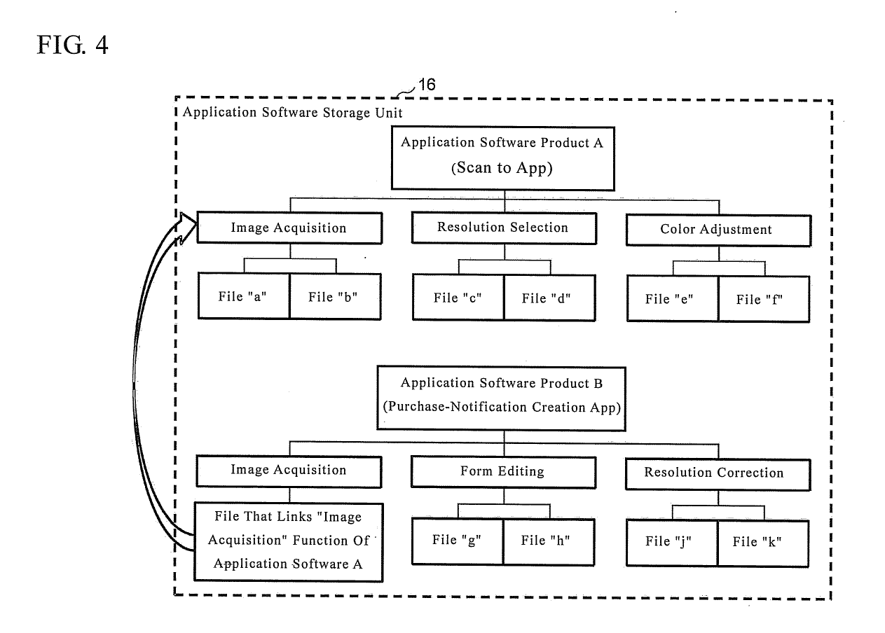

Processes of S14 and S15 will be described in detail with reference to FIG. 3 to FIG. 7. FIG. 3 illustrates a functional configuration of an application software product. Application software product A in each drawing indicates an already-installed application software product stored in the application software storage unit 161. Application software product B in each drawing indicates a new application software product that will be installed. The application software product A has functions of “image acquisition”, “resolution selection”, and “color adjustment.” The application software product B has functions of “image acquisition”, “form editing”, and “resolution correction.” FIG. 4 illustrates a functional configuration of each already-installed application software product stored in the application software storage unit 161.

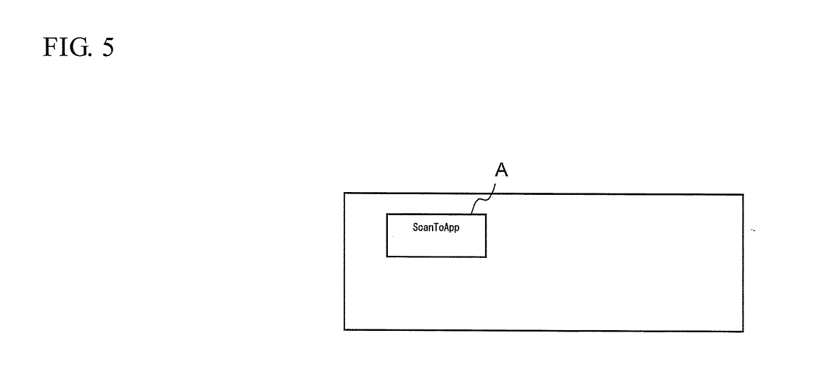

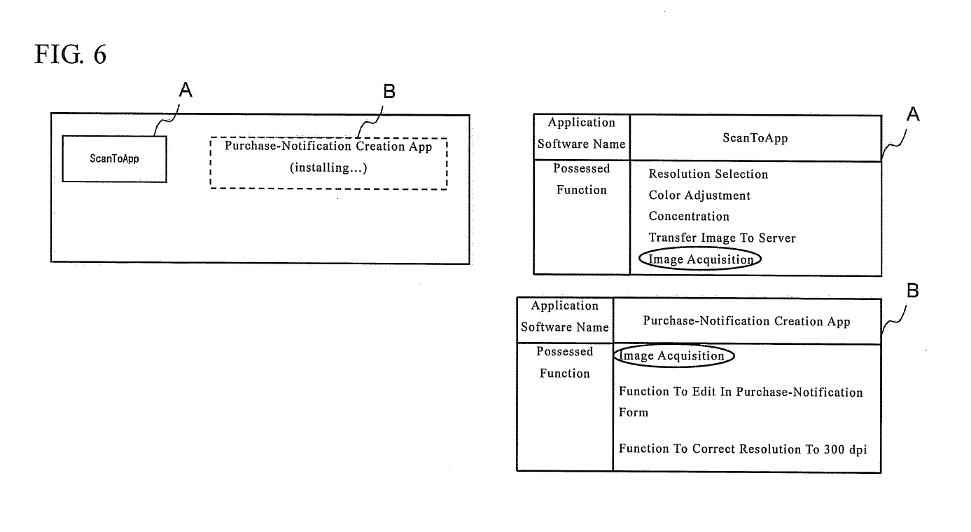

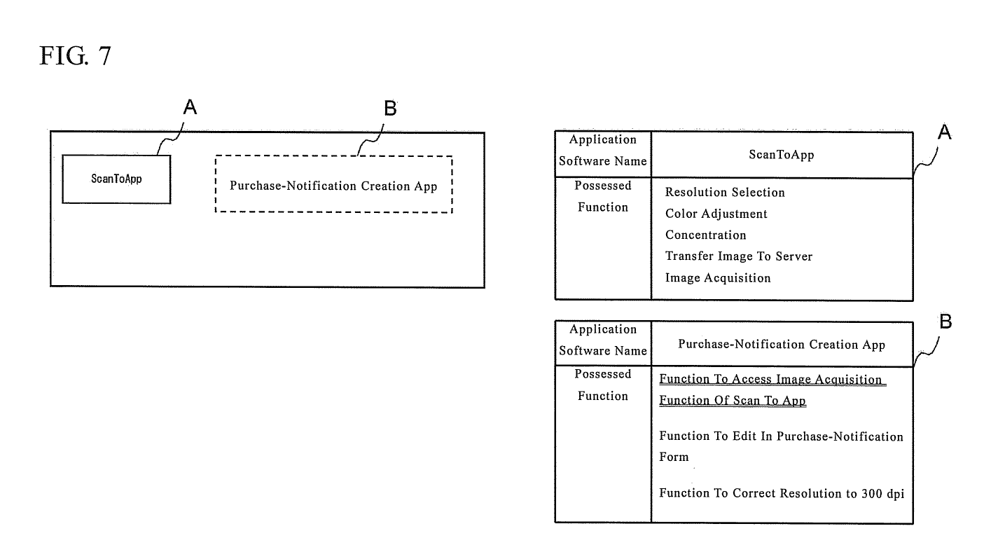

FIG. 5 is a conceptual diagram illustrating an already-installed application software product. FIG. 6 illustrates conceptual diagrams of an already-installed application software product and an application software product newly installed and illustrates functions of each of the application software products. FIG. 7 illustrates conceptual diagrams of an already-installed application software product and an application software product newly installed and illustrates functions of each of the application software products.

As illustrated in FIG. 5, assume that the application software storage unit 161 stores the application software product A (Scan to App application software product). In the case where the application software product B (a purchase-notification creation application software product) is newly installed in this state, the installation control unit 111 compares each function of the application software product A and the application software product B. In this example, as illustrated by ellipses in FIG. 6, the installation control unit 111 determines that the application software product A and the application software product B duplicate the “image acquisition” function, which is incorporated by each application software product A and application software product B. As illustrated in FIG. 7, the installation control unit 111 causes a file “a” and a file “b” of the “image acquisition” function in the application software product B not to be stored (not installed).

Then, as illustrated in FIG. 4, the installation control unit 111 causes: a file content of the “image acquisition” function of the application software product B to be replaced with a file that links the “image acquisition” function of the application software product A, for example, a file indicating a position to which the “image acquisition” function is written in the application software product A; and to be stored. Thus, the “image acquisition” function of the application software product A is linked.

In this embodiment, under a process by the control unit 11, a linked function included in one application software product is executed while being shared with another application software product during execution of a process by the other application software product. In the case where the shared function is concurrently executed by a plurality of application software products, the application software product is prioritized according to an order of an execution request for the function, and then the function is executed on each application software product in this order.

Thus, each application software product to be installed by the installation control unit 111 uses the function of the already-installed application software product for a duplicative function. For the new application software product, the installation control unit 111 causes the duplicative function not to be stored in the application software storage unit 161, thus reducing a waste of the memory resource.

If the link count of one function increases, the following problems, for example, occur. If the linked function is read from a plurality of application software products simultaneously, the application software product with high priority performs reading first and the application software product with low priority stands by for execution of a process, or similar problem occurs. Thus, the processes by the application software product take time and a process load applied to the control unit 11 increases, or similar problem occurs.

Therefore, in this embodiment, the function where the link count has reached the above-described application software value is not further linked. This reduces a process load applied to the control unit 11 when the link source function is simultaneously read from a plurality of application software products, also preventing process time to be wastefully long. The predetermine value is preset by a designer according to a processing capacity of the control unit 11 and processing time of the application software product. According to an execution frequency and a degree of importance of the function, and complication of the process, or a similar condition, a restricting value for the link count (that is, the predetermined value) may differ.

Returning to the description with reference to FIG. 2, next, the link unit 112 updates the link count of the linked functions (functions of the link source) in the installed application software product, and causes the link count storage unit 162 to store the link count (S16). In the case where another new application software product is installed (S18: NO), the installation control unit 111 advances the process to S11. In the case where no other application software product is to be installed (S18: YES), the installation process is terminated.

In the case where the already-installed application software product does not have a function duplicative with a function of the new application software product (S12: NO), or in the case where the link count of duplicative function reaches the predetermined value (S13: YES), the installation control unit 111 stores all the functions of the new application software product into the application software storage unit 161 (S17).

As described above, the functions of the new application software product are compared with the functions of the already-installed application software product, and a duplicative function among the functions of the new application software product is not stored. This reduces a waste of the capacity of the application software storage unit 161.

Then, if the function is thus duplicative, the link unit 112 links the duplicative function of the already-installed application software product to the new application software product. Accordingly, when the duplicative function should be performed based on the new application software product, the function that has already been operationally checked and proved (the duplicative function of the already-installed application software) is used. This allows addition and complement of a new function to the image forming apparatus 1 without degrade by installation.

In this embodiment, the link count of each function of the already-installed application software product is counted, and if the link count of a function reaches the predetermined value, the linking is not performed any further. This prevents an increase in a process load of the control unit 11 and process time by simultaneous reading of one function from many application programs.

In the case where the functions of application software product holds an identification number for each function, the installation control unit 111 can determine whether the functions are duplicative or not by simply comparing the identification numbers, thus ensuring a simplified process.

The disclosure is not limited to the configurations of the embodiments but various modifications are possible. In the embodiments, as an electronic device according to the disclosure, the image forming apparatus 1 formed of a multi-functional peripheral is employed as one embodiment; however, this is merely an example. The electronic device may be another type of image forming apparatus such as a printer, a copying machine, and a facsimile machine. Further, the electronic device may be another type of electronic device such as a medical device and a display device.

The configuration and the process shown in the embodiments with reference to FIG. 1 to FIG. 7 are merely one embodiment of the disclosure. It is not intended to limit the scope of the disclosure to the configurations and the processes.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An electronic device, comprising:
a storage unit configured to store an application software product;
a storage control unit configured to: compare functions of an existing application software product already stored in the storage unit with functions of a new application software product to be installed; control the storage unit to store a file for a function not duplicative with the existing application software product; and control the storage unit not to store a file for a duplicative function, for the new application software product; and
a link unit configured to link location information of the file for the duplicative function of the existing application software product to a position where the file for the function not stored due to the duplication is to be written in the new application software product stored in the storage unit.

2. The electronic device according to claim 1, further comprising
a link count storage unit configured to store a count of each function of the existing application software product linked to another application software product, wherein
in a case where a function of the existing application software product is duplicative with a function of the new application software product and a link count of the duplicative function of the existing application software product stored in the link count storage unit reaches a predetermined count, the storage control unit controls the storage unit to store the file for the duplicative function of the new application software product.

3. The electronic device according to claim 1, wherein
the storage control unit compares a first identification numbers of the function of the new application software product with a second identification numbers of the function of the application software product stored by the storage unit,
in a case where any of the first identification numbers matches any of the second identification numbers, the storage control unit controls the storage unit to store a file for the function of the new application software product where the first identification number does not match any of the second identification number, and controls the storage unit not to store a file for the function of the new application software product where the first identification number matches any of the second identification number.

4. The electronic device according to claim 2, wherein
the storage control unit compares a first identification numbers of the function of the new application software product with a second identification numbers of the function of the application software product stored by the storage unit,
in a case where any of the first identification numbers matches any of the second identification numbers, the storage control unit controls the storage unit to store a file for the function of the new application software product where the first identification number does not match any of the second identification number, and controls the storage unit not to store a file for the function of the new application software product where the first identification number matches any of the second identification number.

5. A non-transitory computer-readable recording medium storing an application software storing program for storing an application software product into a storage unit, the program causing a computer to function as:
a storage control unit configured to: compare functions of an existing application software product already stored in the storage unit with functions of a new application software product to be installed; control the storage unit to store a file for a function not duplicative with the existing application software product; and control the storage unit not to store a file for a duplicative function, for the new application software product; and
a link unit configured to link location information of the file for the duplicative function of the existing application software product to a position where the file for the function not stored due to the duplication is to be written in the new application software product stored in the storage unit.

6. The non-transitory computer-readable recording medium according to claim 5, further causing a computer to function as
a link counting unit configured to count link of each function of the existing application software product linked to another application software product, wherein
in a case where a function of the existing application software product is duplicative with a function of the new application software product and the link count of the duplicative function of the existing application software product stored in the link count storage unit reaches a predetermined count, the storage control unit controls the storage unit to store the file for the duplicative function of the new application software product.

7. The non-transitory computer-readable recording medium according to claim 5, wherein
the storage control unit compares a first identification numbers of the function of the new application software product with a second identification numbers of the function of the application software product stored by the storage unit,
in a case where any of the first identification numbers matches any of the second identification numbers, the storage control unit controls the storage unit to store a file for the function of the new application software product where the first identification number does not match any of the second identification number, and controls the storage unit not to store a file for the function of the new application software product where the first identification number matches any of the second identification number.

8. The non-transitory computer-readable recording medium according to claim 6, wherein
the storage control unit compares a first identification numbers of the function of the new application software product with a second identification numbers of the function of the application software product stored by the storage unit,
in a case where any of the first identification numbers matches any of the second identification numbers, the storage control unit controls the storage unit to store a file for the function of the new application software product where the first identification number does not match any of the second identification number, and controls the storage unit not to store a file for the function of the new application software product where the first identification number matches any of the second identification number.

9. A method for storing an application software product into a storage unit, comprising
comparing functions of an existing application software product already stored in the storage unit with functions of the new application software product to be installed; controlling the storage unit to store a file for a function not duplicative with the existing application software product; and controlling the storage unit not to store a file for a duplicative function, for the new application software product; and
linking location information of the file for the duplicative function of the existing application software product to a position where the file for the function not stored due to the duplication is to be written in the new application software product stored in the storage unit.

10. The method according to claim 9, further comprising
counting each function of the existing application software product linked to another application software product, wherein
in a case where a function of the existing application software product is duplicative with a function of the new application software product and the link count of the duplicative function of the existing application software product stored in the link count storage unit reaches a predetermined count, the comparing controls the storage unit to store the file for the duplicative function of the new application software product.

11. The method according to claim 9, wherein
the comparing includes comparing a first identification numbers of the function of the new application software product with a second identification numbers of the function of the application software product stored by the storage unit,
in a case where any of the first identification numbers matches any of the second identification numbers, the comparing controls the storage unit to store a file for the function of the new application software product where the first identification number does not match any of the second identification number, and controls the storage unit not to store a file for the function of the new application software product where the first identification number matches any of the second identification number.

12. The method according to claim 10, wherein
the comparing includes comparing a first identification numbers of the function of the new application software product with a second identification numbers of the function of the application software product stored by the storage unit,
in a case where any of the first identification numbers matches any of the second identification numbers, the comparing controls the storage unit to store a file for the function of the new application software product where the first identification number does not match any of the second identification number, and controls the storage unit not to store a file for the function of the new application software product where the first identification number matches any of the second identification number.
